(19) United States
(12) Patent Application Publication
(10) Pub. No.: US 2020/0380481 A1
(43) Pub. Date: Dec. 3, 2020

(54) AUTONOMOUS BILL PAY BOT WITH AUTOMATIC SOCIAL OVERDRAFT PROTECTION

(71) Applicant: Wells Fargo Bank, N.A., San Francisco, CA (US)

(72) Inventor: Chris Kalaboukis, San Jose, CA (US)

(21) Appl. No.: 15/869,668

(22) Filed: Jan. 12, 2018

(51) Int. Cl. G06Q 20/10; G06Q 20/40; G06Q 40/02

(52) U.S. Cl. CPC G06Q 20/102; G06Q 40/025; G06Q 20/405; G06Q 20/108

(57) ABSTRACT

A method for autonomous bill payment with automatic social overdraft protection includes pattern mining payment transaction information of a funds account. A future payment transaction is predicted for the funds account. The future payment transaction for the funds account is evaluated against a balance of the funds account to determine a shortfall amount. An automatic funds transfer is initiated from a social lender account to the funds account to cover the shortfall amount, the funds transfer comprising a socially-funded loan. The terms of the socially-funded loan are automatically determined. In some embodiments, a user is associated with a social lender account and is provided with a subscription notification. The subscription notification is structured to allow the user to opt into automatic social overdraft protection.

### BACKGROUND

The proliferation of the internet has fundamentally changed various aspects of individuals' lives, such as communication, work, education, finance, social and personal relationships, etc. For example, the internet has remarkably increased the amount of information available and decreased the transaction cost of obtaining such information. It has also enabled users to send and receive funds electronically, thus facilitating bill payment and personal loans executed through various payment networks between individual users. Further, the internet has enabled crowdsourcing and/or crowdfunding and expanded the pool of available donors and lenders to individual users. However, all of these lending arrangements require users who are in need of funds to first identify the need for funding or a loan and to schedule or otherwise initiate a crowdsourcing request or a payment transaction.

### SUMMARY

One example embodiment relates to a computer-implemented method. The method includes predicting, by one or more processors of a provider computing system, a future payment transaction for the funds account. The funds account is associated with a user of the provider computing system. Predicting a future payment transaction includes generating a transaction pattern repository, the transaction pattern repository comprising at least one attribute descriptive of a property of a payment transaction. Predicting a future payment transaction includes evaluating payment transaction information of the funds account against the at least one attribute. The method includes evaluating the future payment transaction for the funds account against a balance of the funds account to determine a shortfall amount and initiating, by the one or more processors of the provider computing system, a funds transfer from a social lender account to the funds account to cover the shortfall amount. The funds transfer includes a socially-funded loan. The socially funded loan includes automatically calculated terms. The method includes generating a notification and providing the notification to the user. The notification is indicative of the funds transfer and the terms of the socially-funded loan.

Another example embodiment relates to a computing system. The computing system includes a network interface and one or more processors. The one or more processors is/are configured to predict a future payment transaction for the funds account. The funds account is associated with a user of a provider computing system. Predicting a future payment transaction comprises generating a transaction pattern repository. The transaction pattern repository comprises at least one attribute descriptive of a property of a payment transaction. Predicting a future payment transaction comprises evaluating payment transaction information of the funds account against the at least one attribute. The one or more processors is/are configured to evaluate the future payment transaction for the funds account against a balance of the funds account to determine a shortfall amount. The one or more processors is/are configured to initiate, through the network interface, a funds transfer from a social lender account to the funds account to cover the shortfall amount. The funds transfer includes a socially-funded loan. The socially funded loan includes automatically calculated terms. The one or more processors is/are configured to generate a notification and provide, through the network interface, the notification to the user. The notification is indicative of the funds transfer and the terms of the socially-funded loan.

Another example embodiment relates to a non-transitory computer-readable media having computer-executable instructions embodied therein that, when executed by one or more processors of a provider computing system, cause the one or more processors to perform operations. The operations include predicting a future payment transaction for the funds account. Predicting a future payment transaction comprises generating a transaction pattern repository. The transaction pattern repository comprises at least one attribute descriptive of a property of a payment transaction. Predicting a future payment transaction comprises evaluating payment transaction information of the funds account against the at least one attribute. The operations include evaluating the future payment transaction for the funds account against a balance of the funds account to determine a shortfall amount. The operations include initiating a funds transfer from a social lender account to the funds account to cover the shortfall amount. The funds transfer includes a socially-funded loan. The socially funded loan includes automatically calculated terms. The operations include generating a notification and providing the notification to the user. The notification is indicative of the funds transfer and the terms of the socially-funded loan.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a block diagram of a system for autonomous bill payment with automatic social overdraft protection, according to an example embodiment.

FIG. 2 is a flow diagram of a method of autonomous bill payment with automatic social overdraft protection, according to an example embodiment.

FIG. 3 is a flow diagram of a method of matching a loan recipient with one or more social lenders and generating suitable loan terms for an automatic social overdraft protection transaction, according to an example embodiment.

FIG. 4 is an interface on a display of an individual computing device, the interface including graphics displaying enrollment, alert, and loan payoff information for automatic social overdraft protection, according to an example embodiment.

### DETAILED DESCRIPTION

Referring generally to the figures, systems and methods for autonomous bill payment with automatic social overdraft protection according to one or more example embodiments are shown. Herein, “automatic” is defined as pertaining to an electronically carried out action that does not require outside (either human or machine) intervention to be scheduled, triggered, executed, and/or completed. As will be appreciated, a method for autonomous bill payment with automatic social overdraft protection includes pattern mining payment transaction information of a funds account. A future payment transaction is predicted for the funds account. The future payment transaction for the funds account is evaluated against a balance of the funds account to determine a shortfall amount. An automatic funds transfer is initiated from a social lender account to the funds account to cover the shortfall amount, the funds transfer comprising a socially-funded loan. The terms of the socially-funded loan are automatically determined. In some embodiments, a user is associated with a social lender account and is provided with a subscription notification. The subscription notification is structured to allow the user to opt into automatic social overdraft protection.

Bill payment is typically a major time investment, and, in many cases, customers are charged high fees when they miss payments, or show insufficient funds in their accounts. While some bills can easily be placed on autopay, other bills require in-depth view for anomalies, which may or may not be known to the customer. Even after a series of consistent bills, those placed on autopay may still cause funding issues. In cases where funding may be inconsistent, non-payment may occur, which can trigger many possible negative consequences, including fines. Additionally or alternatively, a funding shortfall may result from the customer not having enough money even if bill amounts are consistent.

The autonomous bill pay bot with automatic social overdraft protection can learn a customer's bill payment patterns, integrate them with other customer bill pay patterns, develop best practices for bill payment, alert the customer to out-of-bounds items and invoices prior to payment, and automatically initiate loans between customers to cover shortfalls. The systems and methods disclosed herein can be adapted to monitor the customer's entire bill paying behavior, including all transactions, and develop a bill payment strategy, which may be an extension of the customer's strategy (and, for example, may take into account a customer's savings goal). Once this strategy is developed, the strategy is presented to the customer as a set of rules, which the customer can review and revise, and ultimately put into action.

The bot can then take over all of the activities that the customer needs to undertake in order to pay bills on behalf of the customer. Simultaneously, the bot can share anonymized bill payment strategies in the system, in order to develop best bill pay practices across all users. Finally, the bot has the ability to capture and analyze transactions and flow in and out of all connected accounts, whereby users can opt-in to allow all, or a portion of, their remaining available balance to be loaned to other members via a short term loan, in some cases, in exchange for interest. If the bot detects that a customer may overdraft the customer's account, the bot can automatically effectuate a loan from another account with available funds in order to cover the bill, and then replenish the other account once the original account is replenished.

The embodiments of the autonomous bill pay bot with automatic social overdraft protection described herein improve computer-related technology by performing certain steps that cannot be done by conventional bill payment systems or human actors. For example, the autonomous bill pay bot is configured to perform pattern mining, by one or more processors of a provider computing system, of the payment transaction information of a funds account to automatically predict a future payment transaction for the funds account. Accurate and realistic predictions of future payment transactions are facilitated by generating a transaction pattern repository with at least one attribute descriptive of a property of a past payment transaction and evaluating payment transaction information of the funds account against the at least one attribute to automatically predict a future payment transaction for the funds account. In some embodiments, to achieve benefits over conventional databases where table and field definitions are static, the attribute of the data repository may be data type agnostic and configured to store different information for different users, transaction types, etc. Furthermore, to achieve benefits over conventional databases and to solve a technical problem of improving dimensional scalability (such that different aspects of transactions may be analyzed for different users on the same data storage infrastructure as the autonomous bill pay bot learns the relevant aspects through pattern mining), and faster loan provision services by reducing computer processing times for analyzing loan needs and qualifications of users receiving such services, the data stored in multidimensional form may be aggregated and/or stored using improved methods. For example, summary data may be dynamically calculated after being stored when the data is retrieved for analysis and/or transaction processing.

In an example embodiment, the autonomous bill pay bot includes a particular and unique set of rules, which are set up to account for and learn from specific deviations in user bill payment activity and to produce an accurate prediction for a future bill payment transaction in cases that traditionally would have required human intervention. Additionally, another particular and unique set of rules defines a system that is automated to manage socially funded loans with automatically calculated terms, which traditionally would have required an evaluation by a human being. Further, embodiments described herein solve the internet-centric problem of automating electronic crowdsourcing of funding for loans to optimize aggregate cash flows for multiple individuals. For example, embodiments described herein solve the technical and internet-centric problem of pattern mining transaction data to facilitate the matching of individuals in need of loans to social lenders without the need to trigger the lending process by, for example, posting a new crowdsourcing request on a website, or a requiring a person to submit a loan application. Furthermore, a set of rules defines a process whereby multiple suitable social lenders may be automatically matched to provide funds packaged into a single loan. Real time updates on rewards earned can also be displayed in some embodiments, which encourages or automates early repayment of automatic crowdsourced loans.

In addition, embodiments described herein solve the technical problem of determining the appearance and functionality of an electronic user interface providing real time alerts of automatic loans to account holders. In some embodiments, alerts can be displayed and loan offers accepted with a single click based on a pre-vetted and opted-in account holder.

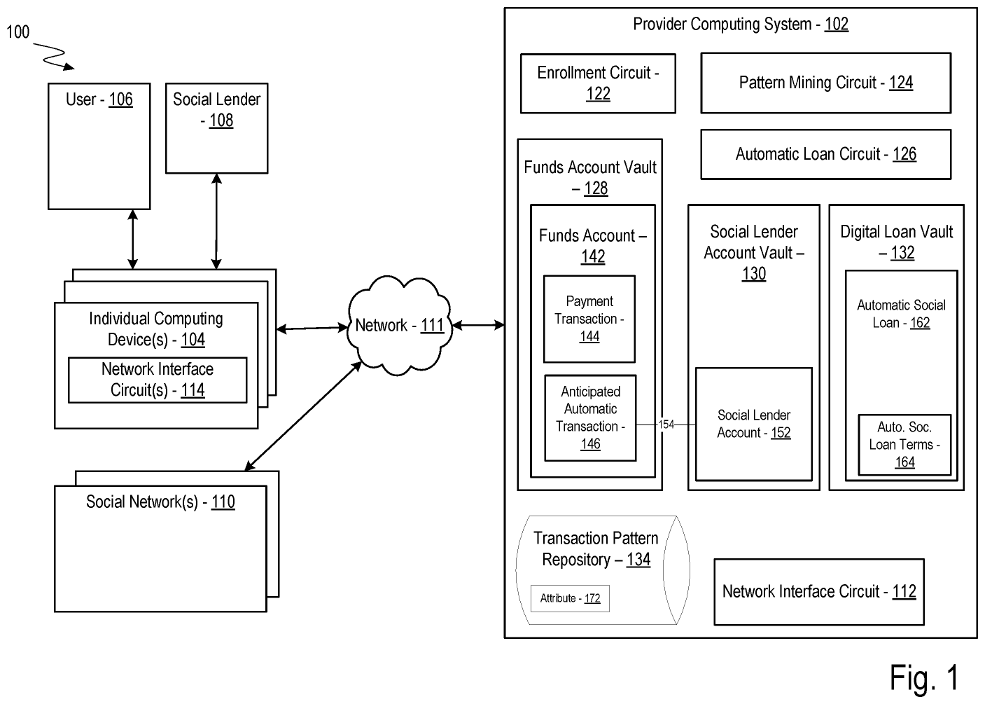

Referring now to FIG. 1, an embodiment of an automated bill pay bot system 100 is depicted. In brief overview, the automated bill pay bot system 100 includes one or more individual computing device(s) 104 used by one or more user(s) 106 and/or by one or more social lender(s) 108. User(s) 106 and social lender(s) 108 may hold one or more accounts with one or more entities (not shown). User(s) 106 may use the one or more accounts to electronically pay various bills, such as installment loan bills, utility bills, etc. The individual computing device(s) 104 are connected to a network 111.

Also connected to the network 111 is a provider computing system 102. In some embodiments, the provider computing system 102 is affiliated with, for example, a bank, a credit union, and the like. In some embodiments, the provider computing system 102 is operated by a trusted intermediary, such as a platform and/or electronic service for connecting borrowers and lenders, processing payments (e.g., paying bills), and/or facilitating secure transactions. In some embodiments, the provider computing system 102 is operated by a provider and/or operator of a social networking environment. In some embodiments, the provider computing system 102 is operated by a cryptocurrency provider, intermediary, and/or payment processor.

Also connected to the network 111 is a social networking platform (social network) 110. In some embodiments, the social networking platform 110 is an electronic social networking site, social media, or another suitable environment that allows a plurality of individuals to build social network(s) based on, for example, activities, backgrounds, shared interests, geographic proximity, real-life personal and/or business connections, and/or other factors. The users of the social networking platform may include the user(s) 106 and the social lender(s) 108. In an example embodiment, at least one user(s) 106 is connected to at least one social lender(s) 108 via the social network(s) 110. In some embodiments, the data from a data vault associated with the social network(s) 110 is accessed and/or received by the provider computing system 102 to identify, create, modify, and manage the connections between and among user(s) 106 and social lender(s) 108, as described further herein.

The individual computing device(s) 104 communicate over the network 111 with the provider computing system 102 and the social network 110. The individual computing device(s) 104, according to various embodiments, may comprise smartphones, laptop computers, tablet computers, e-readers, wearable devices (such as a smart watch, a smart bracelet, and the like), and other suitable device(s). In reference to components described herein, references to the components in singular or in plural form are not intended as disclaimers of alternative embodiments unless otherwise indicated. The components are configured to interact, in some embodiments, as described in further detail below.

In the automated bill pay bot system 100, electronic communication between the individual computing device(s) 104, provider computing system 102, and/or social network 110 is facilitated by the network 111. The network 111 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments or combinations, the network 111 includes a local area network or a wide area network. In some embodiments, the network 111 includes the internet. The network 111 is facilitated by short and/or long range communication technologies, such as Bluetooth® transceivers, Bluetooth® beacons, RFID transceivers, NFC transceivers, Wi-Fi transceivers, cellular transceivers, wired network connections (e.g., Ethernet), etc.

Each of the individual computing device(s) 104 and the provider computing system 102 have respective network interface circuit(s), such as those depicted in FIG. 1 at 114 and 112, respectively. The network interface circuit(s) may include the components described herein and/or additional similar components that allow and/or facilitate connectivity to the network 111. In some embodiments, data that passes through the respective network interface circuit(s) 114 and 112 is cryptographically protected (e.g., encrypted) such that each of the network interface circuit(s) 114 and/or 112 is a secure communication module. In some embodiments, data passing through the respective network interface circuit(s) 114 and 112 is tokenized such that sensitive data (for example, account number(s), user location, personally identifiable information, and the like) are obscured for transmission within or outside the automated bill pay bot system 100.

Still referring to FIG. 1, the individuals using individual computing device(s) 104 are in communication with and/or have accounts with a provider entity, such as the entity and/or intermediary associated with the provider computing system 102. Individuals include at least one user 106 and at least one social lender 108. In some embodiments, individuals include single persons as well as households and families and may also include, companies, corporations, or other entities using the system(s) herein to maintain accounts with provider entities. Individuals communicate via individual computing device(s) 104, and through a respective network interface circuit 114, over the network 111 with the provider computing system 102 and/or social network 110.

The individual computing device(s) 104 are mobile computing systems configured to run applications and communicate with other computer systems over a network 111. For example, the individual computing device 104 may be configured to allow user(s) 106 and/or social lender(s) 108 to view account balances, manage accounts, provide loans, and/or transfer funds from a given account by using, for example, a mobile banking circuit (e.g., a circuit formed at least in part by an application associated with and/or connected to the provider computing system 102 and installed on, or otherwise provided to (for example, using the software-as-a-service delivery model), the individual computing device(s) 104). The mobile banking circuit of the individual computing device(s) 104 may comprise, be part of, and/or be configured to interact with (for example, through an application programming interface (API)) with one or more circuits of the provider computing system 102, which are described further herein.

The provider computing system 102 facilitates autonomous bill payment with automatic social overdraft protection. This is accomplished, in an exemplary embodiment, through automatically learning a payment transaction pattern of the user 106, identifying and managing a likely future transaction, identifying a potential shortfall, finding a suitable social lender 108, dynamically determining loan terms, and triggering a funds transfer to provide the loan to cover the shortfall for the user 106.

According to various embodiments, the provider computing system 102 may include at least one electronic circuit and at least one data storage entity. One or more electronic circuit(s) of the provider computing system 102 may be implemented as software code suitable for compilation, object code, executable file(s) and/or code, a set of machine language instructions, and/or in another suitable form for carrying out the computer-implemented method(s) described herein. In some embodiments, the one or more electronic circuit(s) may be implemented in a distributed fashion such that at least some of the code is executed and/or compiled on the individual computing device(s) 104 and/or by a suitable electronic component associated with the social network 110. One or more data storage entities of the provider computing system 102 may be implemented as an electronic structure(s) suitable for storing information, including, for example, one or more persistent electronic structures, such as one or more database(s), electronic file(s), data mart(s), and the like. The data stored in the one or more data storage entities of the provider computing system 102 may be stored in a multidimensional form such that the structure of the data storage entity has two dimensions (e.g., a look-up table having indexed data) or more (e.g., a relational database, a multi-dimensional database, an online analytical processing (OLAP) cube, etc.). To improve database aggregation time and/or dimensional scalability, the data stored in multidimensional form may be aggregated and/or stored using suitable storage methods such that summary data is calculated prior to being stored (e.g., the block storage method) or is dynamically calculated after being stored when the data is retrieved for analysis and/or transaction processing (e.g., the aggregate storage method).

In an example embodiment of FIG. 1, the provider computing system 102 includes electronic circuits and data storage entities. Electronic circuits of the provider computing system 102 include a network interface circuit 112, an enrollment circuit 122, a pattern mining circuit 124, and an automatic loan circuit 126. The data storage entities of the provider computing system 102 include a funds account vault 128, a social lender account vault 130, a digital loan vault 132, and a transaction pattern repository 134. These circuits and/or data storage entities may be combined as needed such that one or more data storage entities and/or circuit(s) are implemented in a hybrid form. An example of a hybrid implementation is a data storage entity having a shell and/or providing an API such that a library of code (for example, executable functions containing Data Manipulation Language (DML) instructions) may be used by entities within or outside the automated bill pay bot system 100.

As described above, the network interface circuit 112 is structured to enable all or some components of the provider computing system 102 to connect to other systems within or outside the automated bill pay bot system 100.

The enrollment circuit 122 is structured to provide the user(s) 106, through the individual computing device 104, with subscription notifications that allow the user 106 to enroll to become a social lender 108 to other user(s) 106, to receive automatic social overdraft protection from other social lender(s) 108, or both.

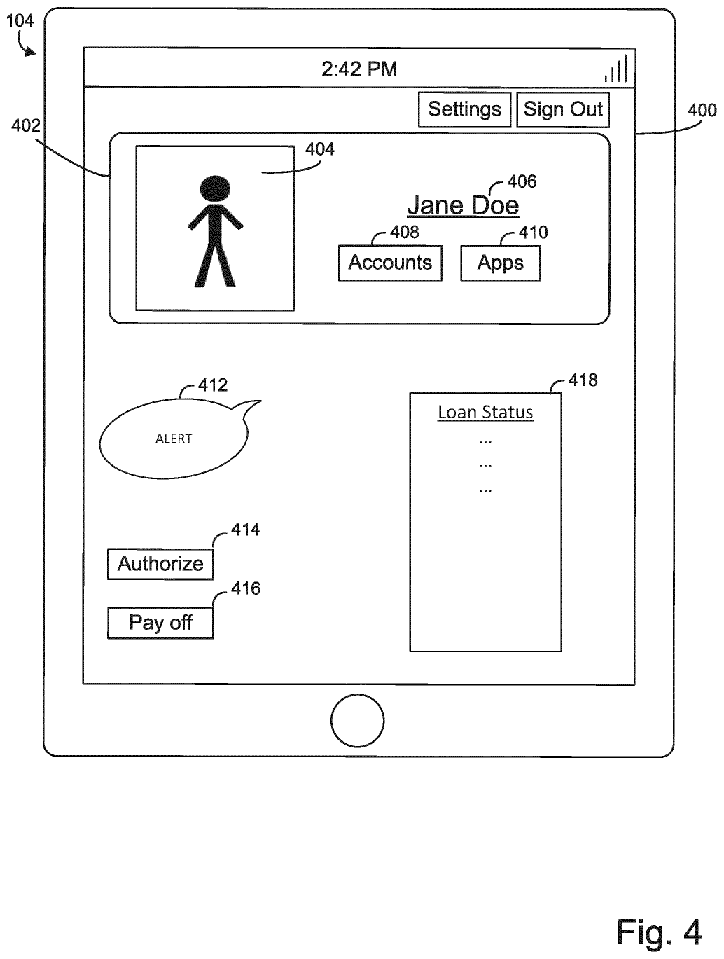

In some embodiments, the enrollment circuit 122 is structured to provide alerts to user(s) 106 and/or social lender(s) 108, through the individual computing device(s) 104, to allow these individuals to receive and respond to notifications related to automatic social overdraft protection. For example, the enrollment circuit 122 may be configured to generate, manage, update, and/or respond to an electronic user interface for interacting with the individual(s) through the individual computing device(s) 104. In some embodiments, such as the embodiment of FIG. 4, the electronic user interface is a graphical user interface (GUI) visually presented to the user(s) 106 and/or social lender(s) 108 through the individual computing device(s) 104. In other embodiments, the electronic user interface may comprise aural, auditory, tactile, kinesthetic and/or haptic system(s) and/or component(s) for notifying and interacting with the user(s) 106. For example, the individual computing device(s) 104 may buzz, vibrate, trigger an LED light indicator, and/or otherwise alert the user(s) 106 and/or the social lender 108 to the alert(s) and/or notification(s) received through the enrollment circuit 122.

In some embodiments, the enrollment circuit 122 allows the user(s) 106 and/or the social lender(s) 108 to authorize a new automatically initiated social overdraft protection activity. For example, when a need for a loan to the user 106 is identified, as described further herein, to cover a shortfall, a suitable social lender 108 is matched to the user 106 to provide the loan, and the user 106 and/or the social lender 108 may be presented with a notification allowing each to confirm that they wish to proceed with the loan. In some embodiments, the user 106 and/or the social lender 108 may modify some aspects of the loan, such as the loan duration, payment date and/or loan amount, as part of the authorization process facilitated by the enrollment circuit 122.

In some embodiments, the enrollment circuit 122 allows the user(s) 106 and/or the social lender(s) 108 to view the status of existing loans and manage these existing loans by, for example, initiating and/or scheduling loan payoff. In some embodiments, the enrollment circuit 122 allows the user(s) 106 to initiate early loan payoff, specify the payment frequency, and otherwise manage the repayment of the loan. In some embodiments, the enrollment circuit 122 administers rewards for the user 106 to encourage early and/or on-time loan repayment to the social lender 108. The rewards may be in the form of cash, bonus points, pre-paid gift cards, preferred social lender access for the user 106, preferred social lender status of the user 106, favorable future loan terms, and the like, as described further herein.

The pattern mining circuit 124 is structured to analyze historical payment transaction information of the user 106 for payment pattern(s) and to generate/initiate processing of an anticipated automatic transaction based on the identified payment pattern(s). Here, pattern mining is defined as an automated and/or automatically triggered traversal and/or evaluation by, for example, a bot, of electronically stored data selected and/or processed according to a specified set of electronically codified rules in order to identify actionable (able to serve as a basis for automatic social overdraft protection) patterns in the data. According to various embodiments, pattern mining may be part of analyzing, evaluating, projecting, and/or predicting the value(s) for various items and/or data points. In some embodiments, the pattern mining circuit 124 is a pattern-based risk management circuit, which is configured to analyze the social lending history and other parameters relevant to automatically determining the loan terms for an automatic social overdraft protection loan between the user 106 and the social lender 108.

In some embodiments, the pattern mining circuit 124 is structured to analyze/mine historical payment transaction information through or using the electronic functionality associated with the funds account vault 128. The funds account vault 128 is structured to facilitate storage, aggregation, and analytics of the payment transaction data associated with a funds account 142 of the user 106. The funds account 142 of the user 106, according to various embodiments, may be an account with the entity or intermediary that operates the provider computing system 102. In some embodiments, the funds account 142 is an electronic ledger stored within the funds account vault 128 of the provider computing system 102. In some embodiments, the funds account 142 is an electronic ledger stored by an entity outside the provider computing system 102, and the provider computing system 102 stores and/or uses the login credentials of the user 106 to access the funds account 142. In some embodiments, the funds account 142 is associated with a mobile wallet of the user 106, such that the user 106 engages in bill payment and/or mobile electronic banking using the funds account 142 accessed and managed through the individual computing device 104.

The funds account 142 includes one or more payment transaction(s) 144, which comprise the historical payment transaction information analyzed by the pattern mining circuit 124. Each of the payment transaction(s) 144 may contain data field(s) associated with the transaction. The data field(s) may be populated with values, such as transaction amount, date, payee identifier (such as a Tax ID), account number of the user 106 with the payee, account balance, account payment terms (such as interest rate, payoff schedule, amortization schedule, and the like), and other similar information. The pattern mining circuit 124 may be structured to analyze any or all of these values as part of mining the historical payment transaction information. For example, the pattern mining circuit 124 may be structured to identify a set of payment transactions 144 suitable for analysis (based on transaction status, transaction date range, payor, or another suitable criterion for pattern mining). Each payment transaction 144 in the set of payment transactions identified by the pattern mining circuit may be traversed to extract the relevant values, and these values may be aggregated, averaged, and otherwise summarized for statistical analysis across multiple payment transactions 144. In some embodiments, some payment transactions 144 of the set of payment transactions are sampled by the pattern mining circuit 124 to, for example, audit and/or identify conformance with loan terms and determine how the activity of the user 106 of the funds account 142 changes over time with respect to the management of the funds account 142.

In some embodiments, the pattern mining circuit 124 is structured to generate/initiate processing of an anticipated automatic transaction based on the identified payment pattern(s) of one or more transactions 144 of the funds account 142. To this end, the funds account vault 128 is structured to comprise one or more electronic item(s) representing one or more anticipated automatic transactions 146. The anticipated automatic transaction 146 is electronically created by the pattern mining circuit 124 based on an identified pattern, such as periodic payments to the same payer, sustained changes in payment amounts to the same payer (such that when the user 106 starts paying more than the minimum balance due each month), termination of periodic payments by the user 106 to the payer while an outstanding balance remains (indicating that the user 106 is behind on payments), a large unusual transaction of the user 106 and the like. Once the anticipated automatic transaction 146 is created, the provider computing system (e.g., the automatic loan circuit 126) is structured to evaluate the anticipated automatic transaction 146 against the balance of the funds account 142 to determine a potential shortfall and initiate automatic social overdraft protection by sourcing a loan from a social lender 108, as described further herein. In some embodiments, the pattern mining circuit 124 is configured to compute an anticipated balance of the funds account 142 on the date of the anticipated automatic transaction 146 by analyzing the history of inflows (such as identifying trends in periodic inbound transfers of funds) and outflows (such as identifying trends in periodic outbound transfers of funds) of the funds account 142.

In some embodiments, the pattern mining circuit 124 is structured to generate/initiate processing of an anticipated automatic transaction based on the identified payment pattern(s). Each of the anticipated automatic transactions 146 may contain data field(s) associated with the transaction. The data field(s) may be populated with values, such as transaction amount, date, payee identifier (such as a Tax ID), account number of the user 106 with the payee, account balance, account payment terms (such as interest rate, payoff schedule, amortization schedule, and the like), and other similar information. In some embodiments, rather than being part of a persistent data storage structure, the electronic item representing an anticipated automatic transaction 146 is dynamically constructed for processing by the automatic loan circuit 126, as described further herein. In some embodiments, at or prior to completion of the processing of the automatic loan circuit 126, the pattern mining circuit 124 is structured to modify and/or destroy the anticipated automatic transaction 146. In some embodiments, the anticipated automatic transaction 146 is destroyed once the funds transfer and/or a loan is completed. In some embodiments, the anticipated automatic transaction 146 is converted to a payment transaction 144 for subsequent analysis and pattern mining by the pattern mining circuit 124.

In some embodiments, the pattern mining circuit 124 is a pattern-based risk management circuit, which is configured to analyze the social lending history and other parameters relevant to automatically determining the loan terms for an automatic social overdraft protection loan between the user 106 and the social lender 108. For example, the pattern mining circuit 124 may be configured to mine social and lender risk data for the user 106 and the social lender 108 to determine a suitable lender for a loan associated with automatic social overdraft protection to cover the shortfall as necessary to complete the anticipated automatic transaction 146. In some embodiments, the social and lender risk data includes attributes of a social lending relationship 154 (described further herein) between the user 106 and the social lender 108. For example, the pattern mining circuit 124 may access the user profiles of the social network 110 to evaluate any familial or social relationship to determine the degree of familiarity between the individuals. In some embodiments, the user 106 may further designate one or more social lender(s) 108 or groups thereof to evaluate for automatic social overdraft protection in a tiered manner, such that, for example, the provider computing system 102 can attempt to first secure a loan from the family members of the user 106, then from friends of the user 106, then from other individuals not previously having issued any social loans to the user 106, and finally from all remaining individuals in the social network 110 of the user 106. The pattern mining circuit 124 may generate and/or assess one or more historical records comprising information on a prior loan between the individuals to make this determination. The information on a prior loan may include loan amount, repayment status, loan terms, interest rate, and the like.

In some embodiments, the pattern mining circuit 124 is a pattern-based funds maximization circuit, which is structured to optimize the savings and/or cash flow of the funds account 142 by determining the optimal loan terms for an automatic social overdraft protection loan between the user 106 and the social lender 108. In some embodiments, the funds account 142 is interest-bearing. The pattern mining circuit 124 may be structured to select a calendar date from a range of acceptable calendar dates for the anticipated automatic transaction 146 such that the average daily balance of the funds account 142 is maximized to increase an amount of interest earned by the user 106 through the funds account 142. In some embodiments, the pattern mining circuit 124 is structured to analyze average monthly funds inflow information for the funds account 142 in relation to average monthly funds outflow information and/or to the aggregate amount of one or more anticipated automatic transactions 146. Based on this information, the pattern mining circuit 124 is structured to predict a series of pre-defined time periods, each of the series of pre-defined time periods associated with a predicted recurring shortfall. The pattern mining circuit 124 is structured to initiate, for each of the series of pre-defined time periods, a series of recurring automatic socially-funded loans such that the user 106 receives automatic social overdraft protection for more than a single anticipated automatic transaction 146. In some embodiments, the pattern mining circuit 124 is structured to make recommendations to the user 106 and to generate anticipated automatic transaction 146 based on algorithms that evolve as the provider computing system 102 learns about the user 106 over time. For example, the pattern mining circuit 124 may be structured to dynamically select a new social lender 108, for each of the series of recurring automatic socially-funded loans, at the time each of the series of recurring automatic socially-funded loans is initiated such that each current match of the user 106 with the social lender 108 minimizes a loan cost for the user 106. To accomplish an optimized match between the user 106 and the social lender 108, the pattern mining circuit 124 may be structured to evaluate one or more attributes of each automatic social loan.

In some embodiments, the pattern mining circuit 124 is structured to maintain a transaction pattern repository 134 of the provider computing system 102. The transaction pattern repository provides a data structure to store and/or manage at least one attribute 172. The attribute 172 may be associated with an individual (such as login information, PIN numbers, social network aliases and the like of the user 106 and/or the social lender 108), a transaction (such as transaction amount, date, payee identifier (such as a Tax ID), account number of the user 106 with the payee, account balance, account payment terms (such as interest rate, payoff schedule, amortization schedule, and the like), a loan (such as the interest rate and other loan terms (amount, payment amounts, duration, payment frequency)), and other similar information. In an example embodiment, the transaction pattern repository 134 is a database optimized for database aggregation time, data retrieval time, and/or dimensional scalability as described herein in relation to various implementations of the data storage entities of the provider computing system 102. In some embodiments, the transaction pattern repository is optimized for providing, by the enrollment circuit 122, statistical and analysis data on the loan activity to the user 106 and/or the social lender 108, as described in reference to FIG. 4. In some embodiments, the pattern mining circuit 124 contains a library of code and/or executable code packages that is implemented as wrap-around functionality, such as a shell, for one or more data storage objects comprising the transaction pattern repository 134.

The transaction pattern repository 134 may be structured to provide an API such that a library of code associated with the functionality of the circuits of the provider computing system 102 may be accessed by components within or outside the automated bill pay bot system 100. In some embodiments, the executable code package(s) may be provided, in a software-as-a-service fashion, for execution by or on the individual computing device 104. According to various embodiments, some or all electronic components of the electronic user interface provided to the user 106 through the individual computing device 104 may be generated, set, re-set, and/or populated with data by one or more processes running on the individual computing device 104 and/or managed by a processor of the individual computing device 104 such that executable code packages can be accessed by, stored, compiled and/or executed through instructions stored in a memory module of the individual computing device 104.

The automatic loan circuit 126 is structured to generate an automatic social loan from the social lender 108 to the user 106 and to transfer funds from an account of the social lender 108 to the funds account 142 of the user 106 in order to cover the shortfall associated with the anticipated automatic transaction 146 of the user 106.

In some embodiments, the automatic loan circuit 126 is structured to generate an automatic social loan from the social lender 108 to the user 106 through or using the electronic functionality associated with the social lender account vault 130 and/or the digital loan vault 132. The social lender account vault 130 is structured to facilitate storage, aggregation, and analytics of the transaction data associated with a social lender account 152 of the social lender 108. In some embodiments, the social lender 108 is the user 106 such that the user 106 both receives and provides loans to and from other individuals and such that the social lender account 152 of the social lender 108 is the funds account 142 of the user 106. The social lender account 152 of the social lender 108, according to various embodiments, may be an account with the entity or intermediary that operates the provider computing system 102. In some embodiments, the social lender account 152 of the social lender 108 is an electronic ledger stored within the social lender account vault 130 of the provider computing system 102. In some embodiments, the social lender account 152 is an electronic ledger stored with an entity outside the provider computing system 102, and the provider computing system 102 stores and/or uses the login credentials of the social lender 108 to access the social lender account 152. In some embodiments, the social lender account 152 is associated with a mobile wallet of the social lender 108, such that the social lender 108 engages in bill payment and/or mobile electronic banking using the social lender account 152 accessed and managed through the individual computing device 104.

The social lender account 152 is a source of funds for automatic social overdraft protection through one or more loans managed by the automatic loan circuit 126. A social lending relationship 154 is formed between the user 106 and the social lender 108 when the automatic loan circuit 126 initiates and/or finalizes the loan. In some embodiments, the social lending relationship is an electronic item generated by, for example, the pattern mining circuit 124, as a digital item and/or data structure having one or more field(s) describing the details of the relationship and previous loans and/or other transactions between the user 106 and the social lender 108. In some embodiments, the pattern mining circuit 124 is structured to access and/or otherwise obtain login information of the user 106 and/or the social lender 108 to an auxiliary system, such as the social network 110, in order to analyze (e.g., through iteration, sequential processing of records, accessing specific records according to criteria) and/or evaluate the social relationship data provided therefrom. In some embodiments, the pattern mining circuit 124 is structured to access and/or import for analysis the loan information from external systems (e.g., property recordation systems, financial institutions) in order to determine the aspects of the social lending relationship 154. The social lending relationship 154 may include individual and loan information, such as credit score(s), desired loan terms, actual loan terms, repayment history, and the like. As described above, the social lending relationship 154 may be evaluated by the pattern mining circuit 124 to match a suitable social lender 108 to a user 106.

The automatic loan circuit 126 accesses and/or otherwise obtains the profile data on the user 106 and the social lender 108 to initiate the creation of a record for an automatic social loan 162 in the digital loan vault 132. The profile data may include individual information, tax identification number(s), address, telephone number, social networking alias, login information for various systems used to assess transaction risk and/or determine the social lending relationship 154, etc. The digital loan vault 132 is structured to facilitate storage, aggregation, and analytics of the automatic social overdraft protection data associated with a loan from the social lender 108 to the user 106. The digital loan vault 132 comprises one or more data structures (such as records) that include information about one or more automatic social loans 162.

Each automatic social loan 162 comprises automatic social loan terms 164. Automatic social loan terms 164 are point-in-time and/or historical data items on the various properties associated with each loan, including, for example, profile data for the user 106 and the lender 108, a pointer or similar reference to the social lending relationship 154, an interest rate, a payoff schedule, an amortization schedule, a loan amount, a payment amount, a loan duration, payment frequency, lender or third-party rewards for early repayment, etc. The automatic loan circuit 126 generates the automatic social loan terms 164 based at least in part on the information determined by the pattern mining circuit 124 described above. This information may include, for example, risk preferences of the user 106 and/or the lender 108, social lending relationship 154, any loan thresholds pre-defined by the user 106 and/or the lender 108, and the like.

In some embodiments, the automatic loan circuit 126 is structured to transfer funds from the social lender account 152 of the social lender 108 to the funds account 142 of the user 106. In some embodiments, the automatic loan circuit 126 is configured to transfer the funds to an account of the payee of the user 106 rather than to the funds account 142 of the user 106. In some embodiments, the automatic loan circuit 126 is configured to transfer the funds for the loan immediately upon receiving a confirmation from the user 106 and/or the social lender 108. In some embodiments, there may be another triggering event before the funds for the loan are transferred, such as, for example, a scheduled date of the anticipated automatic transaction. The loan funds may be transferred just in time to execute the anticipated automatic transaction 146. In some embodiments, prior to the funds transfer, the automatic loan circuit 126 is configured to check the balance of the funds account 142 of the user 106 relative to the amount of the anticipated automatic transaction 146 to determine whether a shortfall still exists. According to various embodiments, the automatic loan circuit 126 may use the preferred funds transfer method(s) of the user 106 and/or the social lender 108. The funds may be transferred from the social lender account 152 to the funds account 142 using a suitable payment network and/or protocol, such as automated clearing house (ACH), PayPal™, Google Pay™, BitPay™ Wirex™, etc.

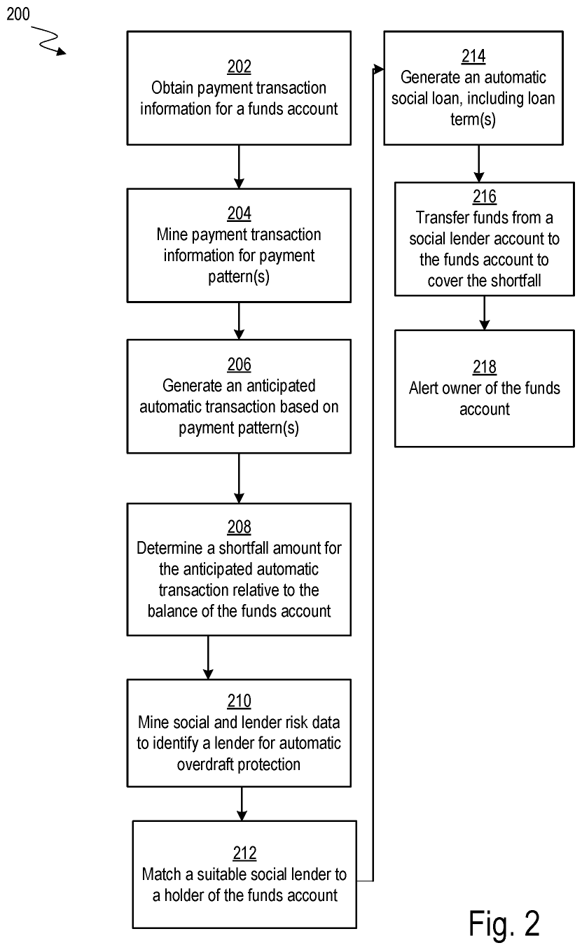

Referring now to FIG. 2, a flow diagram of a method 200 of autonomous bill payment with automatic social overdraft protection, according to an example embodiment, is shown. In some embodiments, the method 200 is performed by the provider computing system 102 and/or the individual computing device 104 such that some or all of the functionality of the electronic circuits of the provider computing system 102 is performed on and/or by the individual computing device(s) 104 of the user 106 and/or the social lender 108. In some embodiments, the method 200 is performed by the enrollment circuit 122, pattern mining circuit 124, and/or automatic loan circuit 126 of the provider computing system 102. While performing the method 200, the provider computing system 102, for example, communicates data over the network interface circuit 112 of the provider computing system 102, and the individual computing device(s) 104 communicate data over the network interface circuit 114 of the individual computing device(s) 104. The method 200 comprises obtaining payment transaction information for a funds account, mining payment transaction information for payment patterns, generating an anticipated automatic transaction, determining a shortfall amount, mining social and lender risk data to find a social lender, matching a social lender with the holder of the funds account, generating an automatic social loan, transferring funds, and generating alert(s) and/or notification(s).

At 202, the pattern mining circuit 124 is structured to obtain information on payment transaction(s) 144 for a funds account 142. The funds account 142 is the account used by the user 106 to make outbound bill payments. In some embodiments, the funds account 142 is operated by a user of the provider computing system 102. In some embodiments, information for a payment transaction 144 is retrieved after querying and/or otherwise traversing the electronic data items contained in the funds account vault 128. In some embodiments, information for a payment transaction 144 is pushed or otherwise transferred from an auxiliary system after the user 106 supplies login credentials for the auxiliary system. In some embodiments, the login credentials are stored by the provider computing system 102 thereon or on the individual computing device 104. Each of the payment transaction(s) 144 may contain data field(s) associated with the transaction. The data field(s) may be populated with values, such as transaction amount, date, payee identifier (such as a Tax ID), account number of the user 106 with the payee, account balance, account payment terms (such as interest rate, payoff schedule, amortization schedule, and the like), and other similar information.

At 204, the pattern mining circuit 124 is structured to mine the information on payment transaction(s) 144 for the funds account 142 (for example, as described in reference to FIG. 1) to predict a future payment transaction for the funds account 142 and to generate, at 206, an anticipated automatic transaction 146. In some embodiments, the pattern mining process by the pattern mining circuit 124 comprises generating and/or updating the transaction pattern repository 134. The transaction pattern repository comprises at least one attribute 172 descriptive of a property of a payment transaction. The attribute 172 may describe an individual (such as login information, PIN numbers, social network aliases and the like of the user 106 and/or the social lender 108), a transaction (such as transaction amount, date, payee identifier (such as a Tax ID), account number of the user 106 with the payee, account balance, account payment terms (such as interest rate, payoff schedule, amortization schedule, and the like), a loan (such as the interest rate and other loan terms (amount, payment amounts, duration, payment frequency)), and other similar information. In some embodiments, the pattern mining process by the pattern mining circuit 124 comprises evaluating the information on payment transaction(s) 144 of the funds account 142 against the at least one attribute 172 to predict a future payment transaction (such as the anticipated automatic transaction 146) for the funds account 142.

In some embodiments, the pattern mining process by the pattern mining circuit 124 comprises combining transaction history data for multiple users. In an example embodiment, the user 106 is a first user and the funds account 142 is a first funds account. The pattern mining process comprises generating a first data set comprising information on payment transaction(s) 144 associated with the first funds account operated by the first user of the provider computing system 102. The pattern mining process further comprises generating a second data set comprising payment transaction information associated with a second account operated by a second user of the provider computing system, the second user being different from the first user. The pattern mining process further comprises electronically integrating the first data set and the second data set to generate and/or update the transaction pattern repository 134. For example, the pattern mining circuit 124 may be configured to identify any of the following collection(s) of electronic records: an intersection of the first data set and the second data set, a difference between the first data set and the second data set, a combination of the first data set and the second data set, and/or any of the foregoing based on aggregated data from the first data set and the second data set. The data may be aggregated based on a relevant property of the payment transaction 144 such as, for example, a subset of payer(s) associated with both the first user and the second user, a subset of payment transaction(s) 144 performed by both the first user and the second user on the first of every month, etc. The attribute 172 of the transaction pattern repository 134 may be populated based on this relevant property of the payment transaction 144. The pattern mining process further comprises evaluating each record/electronic item of the first data set and the second data set against the value of the attribute 172 to predict the future payment transaction (anticipated automatic transaction 146) for the first account of the user. As an example, the first user and the second user may typically make a loan payment to the same payer (such as a holder of an installment automotive loan) around the same time of the month. The first user may need a loan from the second user to cover the first user's shortfall. Upon learning this information, the pattern mining circuit 124 may package the second user's monthly automotive loan payment with the shortfall loan amount of the first user such that two auto loan payments are aggregated in a single outbound transaction and/or in a single electronic remittance file from the social lender account 152 (which, in this case, is also the funds account 142 of the second user) to the holder of both automotive loans. In some embodiments, a new anticipated automatic transaction 146 is generated, at 206, for this outbound funds transfer, and a new record for an automatic social loan 162 is generated and stored in the digital loan vault 132 to denote the loan from the second user to the first user covers the first user's shortfall on the first user's automotive loan payment.

In some embodiments, the pattern mining process includes excluding, from the first data set, the anticipated automatic transaction 146 if it determined to be a payment on a previously taken socially-funded loan. In this manner, users are discouraged and/or prevented from taking on socially-funded loans to pay off other socially-funded loans, and system abuse is minimized while the flow of funds is optimized across at least two participants in automatic social overdraft protection.

At 208, the pattern mining circuit 124 is structured to determine a shortfall amount of the anticipated automatic transaction 146 relative to the balance of the funds account 142. The pattern mining circuit is structured to evaluate the amount of the anticipated automatic transaction 146 for the funds account 142 against a balance of the funds account 142 to determine a shortfall amount. In some embodiments, the evaluation happens substantially contemporaneously or less than a second after the pattern mining is completed at 204. In some embodiments, the balance of the funds account 142 is a current point-in-time balance. In some embodiments, the balance of the funds account 142 is an anticipated future balance as of the date of the anticipated automatic transaction 146. The anticipated future balance may be calculated based on a value of the attribute 172 of the transaction pattern repository 134 such that additional future anticipated automatic transaction(s) are generated and taken into account with respect to their effect on the anticipated future balance.

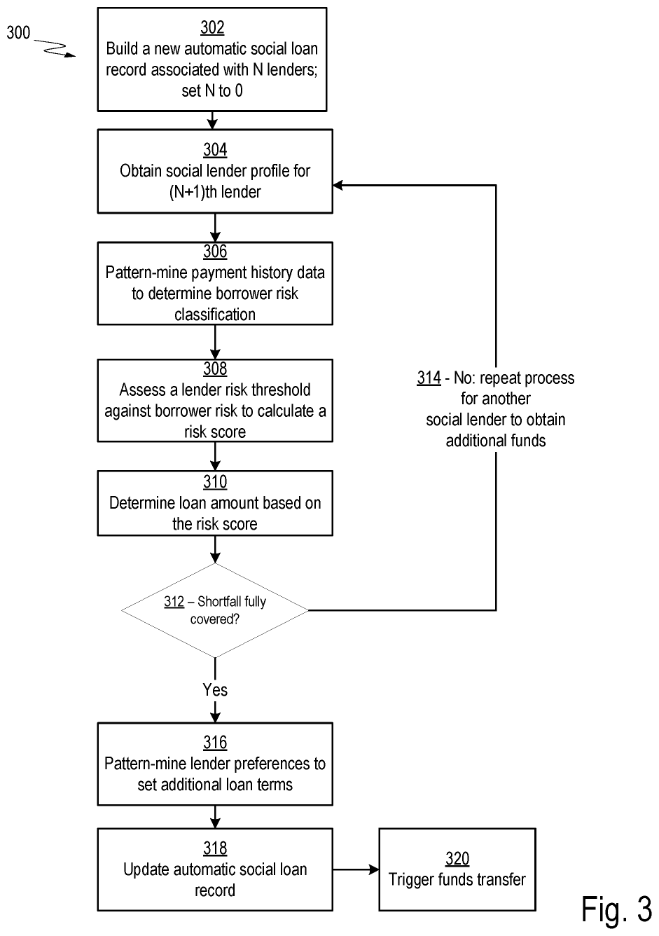

At 210, the pattern mining circuit 124 is structured to mine social and lender risk data (e.g., as described in reference to FIG. 1) to select a lender for performing automatic overdraft protection for the user 106 holding the funds account 142 that is expected to have the shortfall calculated at 208. In some embodiments, the social and lender risk data includes attributes of the social lending relationship 154 between the user 106 and the social lender 108. In some embodiments, the social and lender risk data include, for example, a loan amount threshold set by the social lender 108. If the threshold is set such that the shortfall amount of the user 106 is not fully covered, multiple loans may be originated to cover the shortfall, as described in reference to FIG. 3.

At 212, the pattern mining circuit 124 is structured to match the social lender(s) identified at 210 to the user 106. In some embodiments, the provider computing system 102 is configured to create an automatic social loan record 162 in the digital loan vault 132 to record the match, as described in reference to FIG. 1. The provider computing system 102 may be configured to populate and/or update the automatic social loan record 162 with profile information for user 106 and/or the social lender 108, such as tax identification number(s), address, telephone number, social networking alias, login information for various systems used to assess transaction risk and/or determine the social lending relationship 154, etc.

At 214, the automatic loan circuit 126 is structured to determine/compute and populate the automatic social loan terms 164 of the automatic social loan 162. As described above, each automatic social loan 162 comprises automatic social loan terms 164. Automatic social loan terms 164 are point-in-time and/or historical data items on the various properties associated with each loan, including, for example, profile data for the user 106 and the lender 108, a pointer or similar reference to the social lending relationship 154, an interest rate, a payoff schedule, an amortization schedule, a loan amount, a payment amount, a duration, payment frequency, lender or third-party rewards for early repayment, etc. Automatic social loan terms 164 may be determined by the preferences of the user 106 (e.g., based on a list of preferred social lenders) and/or of the social lender 108 (e.g., based on the risk score of the user 106 and/or a threshold of the social lender 108 for the loan amount and/or repayment term duration).

At 216, the automatic loan circuit 126 is structured to initiate a transfer of funds from the social lender account 152 to the funds account 142 of the user 106 to cover the shortfall and provide automatic social loan protection through a socially-funded loan. In some embodiments, the funds transfer takes place contemporaneously or shortly after determining the shortfall amount and finding a suitable social lender 108. In some embodiments, the funds transfer is scheduled to occur at a later time or date. In some embodiments, the funds transfer occurs directly to the payee of the user 106 rather than to the funds account of the user 106.

At 218, the automatic loan circuit 126 is structured to provide an alert and/or notification to the user 106 and/or the lender 108 as described, for example, in reference to FIG. 4.

FIG. 3 is a flow diagram of a method of matching a loan recipient with one or more lenders and generating suitable loan terms for the automatic social overdraft protection transaction, according to an example embodiment.

Referring now to FIG. 3, a flow diagram of a method 300 of matching a loan recipient with one or more lenders and generating suitable loan terms for the automatic social overdraft protection transaction is shown according to an example embodiment. In some embodiments, the method 300 is performed by the provider computing system 102 and/or the individual computing device 104 such that some or all of the functionality of the electronic circuits of the provider computing system 102 is performed on and/or by the individual computing device(s) 104 of the user 106 and/or the social lender 108. In some embodiments, the method 300 is performed by the pattern mining circuit 124 and/or automatic loan circuit 126 of the provider computing system 102. While performing the method 300, the provider computing system 102, for example, communicates data over the network interface circuit 112 of the provider computing system 102, and the individual computing device(s) 104 communicate data over the network interface circuit 114 of the individual computing device(s) 104. The method 300 comprises building a new automatic social loan record starting with N lenders, N being set to zero, obtaining a social lender profile for the (N+1)^{th} social lender, pattern mining payment history data for the borrower, assessing the (N+1)^{th} social lender's risk, determining loan amount based on the risk assessment, obtaining additional funds from other lenders to cover any remaining shortfall, setting additional loan terms, updating the loan record, and triggering a funds transfer.

At 302, the automatic loan circuit 126 is structured to build a new automatic social loan 162 in the digital loan vault 132. The automatic social loan 162 includes automatic social loan terms 164. Also at 302, the number of social lenders 108 for the automatic social loan 162 is set to zero as a new automatic social loan 162 is initialized.

At 304, the pattern mining circuit 124 is structured to obtain a social lender profile for the (N+1)^{th} social lender 108. Thus, in the first iteration of method 300, the social lender 108 profile information is obtained for the first social lender 108. The social lender 108 profile may be accessed on the provider computing system 102 and/or may be provided by an auxiliary system, such as the social network 110. In some embodiments, the social lender 108 profile is stored on and/or provided by the individual computing device 104 of the social lender 108. The profile information may include individual information, tax identification number(s), address, telephone number, social networking alias, login information for various systems used to assess transaction risk and/or determine the social lending relationship 154 between the social lender 108 and the user 106, etc. In the example embodiment, the profile information includes a lender risk threshold set by or for the social lender 108 for any socially-funded loans issued by the social lender 108. The threshold may include a maximum loan amount, a minimum risk score for the user 106, etc.

At 306, the pattern mining circuit 124 is structured to pattern mine payment history data for the borrower. In some embodiments, the process at 306 includes an analysis of the social lending relationship 154 between the user 106 and the lender 108 as described, for example, in reference to FIG. 2. In some embodiments, the process at 306 includes accessing and/or generating a borrower risk score for the user 106. The borrower risk score may include, for example, a credit score received in a data feed or by dynamically accessing a record of the user 106 maintained by a credit reporting agency such as Experian™, TransUnion™, etc. and/or an internal risk score maintained by the operator of the provider computing system 102. In some embodiments, the internal risk score is calculated based on a value of the attribute 172 of the transaction pattern repository for a relevant subset of prior payment transaction(s) 144 for the user 106. For example, the internal risk score may be calculated by evaluating the transaction date against the payee's due date to determine if the user 106 habitually pays on time. Other examples include: evaluating a number of non-sufficient funds (NSF) instances for the user 106 for a specific payee over a specific date range, evaluating prior repayment history of socially-funded loans to other lenders, etc. In some embodiments, the internal risk score is pre-set for the user 106 by the lender 108 or another entity.

At 308, the pattern mining circuit 124 is structured to assess the (N+1)^{th} social lender's risk. In some embodiments, the borrower risk score for the user 106 is calculated after this assessment is performed. For example, the provider computing system 102 may maintain a look-up table having indexed data of weight factors assigned by each social lender 108 to various risk categories, such as history of late payments, history of NSF, prior social lender relationships, etc. Thus, a raw borrower risk score may be calculated at 306 and may be adjusted up or down at 308 to reflect the (N+1)^{th} social lender's 108 preferences. In some embodiments, determining the risk score for the (N+1)^{th} social lender 108 may include assessing the loan amount threshold set by the (N+1)^{th} social lender 108. For example, the (N+1)^{th} social lender 108 may issue higher-amount loans to users 106 with more favorable risk profiles. In some embodiments, determining the risk score for the (N+1)^{th} social lender 108 may include assessing the degree of familiarity between the user 106 and the social lender 108. For example, the risk score may be lower for a loan where the user 106 is a son or daughter of the social lender 108 compared to a risk score for parties with less of a social connection.

At 310, the pattern mining circuit 124 is structured to determine the loan amount for the automatic social loan 162 from the (N+1)^{th} social lender 108 to the user 106. In some embodiments, the loan amount is determined by comparing the shortfall to the loan amount threshold set by the (N+1)^{th} social lender 108.

At 312, the pattern mining circuit 124 is structured to determine if the shortfall is fully covered. If it is determined that the shortfall is not fully covered, the pattern mining circuit 124 is structured to, at 314, repeat all or some of the steps 302-312 for another social lender 108 to secure additional funding. When it is determined that the shortfall is fully covered, the system proceeds to 316.

At 316, the pattern mining circuit 124 is structured to pattern mine the preferences of the (N+1)^{th} social lender 108 (and any additional social lenders 108 if multiple loans were needed to cover the shortfall) to determine additional automatic social loan terms 164 other than the loan amount. The automatic social loan terms 164 may include an interest rate, a payoff schedule, an amortization schedule, a loan amount, a payment amount, a loan duration, payment frequency, lender or third-party rewards for early repayment, etc. In some embodiments, the automatic social loan terms 164 are calculated for each (N+1)^{th} social lender 108 that provide automatic social overdraft for the user 106 based on the preferences defined and stored by or for each (N+1)^{th} social lender 108. For example, the provider computing system 102 may maintain a look-up table having indexed data of preferences for automatic social loan terms 164 for each social lender 108. The preferences may include a set of discrete values, a range having an upper and/or lower bound for each of the automatic social loan terms 164, etc.

At 318, the pattern mining circuit 124 is structured to update the automated social loan 162 with the information on the automatic social loan terms calculated at 316.

At 320, the pattern mining circuit 124 is structured to initiate a funds transfer from each of the social lender account(s) 152 associated with each of the (N+1)^{th} social lender 108 contributing to the automatic social loan 162 to the funds account 142 of the user 106. In some embodiments, the funds are transferred directly to the payee of the user 106 instead of being transferred to the funds account 142 of the user 106.

Referring now to FIG. 4, an interface 400 on a display of an individual computing device 104 is shown, according to an example embodiment. The interface 400 includes graphics displaying enrollment, alert, loan status, and loan payoff information for automatic social overdraft protection. The interface 400 is provided to the user 106 and/or the lender 108 through the individual computing device 104. The interface 400 on a display of an individual computing device 104 includes an account holder's information 402 for the user 106, including an avatar 404, a username 406, an accounts button 408, and an apps button 410. In some embodiments, the accounts button 408 provides access to one or more accounts (e.g., the funds account 142 and/or the social lender account 152) of the user 106 and/or the lender 108, where the accounts are held with a provider and/or an intermediary. In some embodiments, the apps button 410 provides access to one or more applications installed on the individual computing device 104, which may interface (through, for example, an API) with the one or more accounts of the user 106 and/or the lender 108.

In some embodiments, a graphic is generated based on a social overdraft protection activity, such as an automatic social loan 162. For example, the graphic may include an alert 412 indicating a new automatic social loan 162 was generated involving the user 106 and/or the social lender 108. According to various embodiments of the graphical user interface version of an electronic user interface of the individual computing device 104, the alert 412 may be delivered as a pop-up, an updated and newly rendered digital container/form containing other graphics controls for the interface 400, a text message, an email, and the like. In some embodiments, the user 106 and/or social lender 108 of the individual computing device 104 can click on the alert 412 to obtain more information on the counterparty to the automatic social loan 162, the anticipated automatic transaction 146, and/or the automatic social loan terms 164. In some embodiments, the automatic social loan 162 can be immediately authorized by using an authorize button 414. The new automatic social loan 162 generated and/or activated by the acceptance may then shortly be accessible to the user 106 and/or the social lender 108 by using the accounts button 408. The loan status of any pending or current new automatic social loan 162 may be displayed in a loan status information window 418. In some embodiments, the user 106 and/or the social lender 108 may navigate (scroll through or otherwise traverse using the interface 400) the list of automatic social loan(s) 162 in the loan status information window 418. The user loan status information window 418 may select an automatic social loan(s) 162 and user the payoff button 416 to initiate the loan repayment process and/or set up recurring payments.

Other indications may be displayed including one or more parameters associated with receiving and providing a loan solution (e.g., an icon, badge, etc.) of for the user 106 and/or social lender 108. The graphic may include an image, icon, badge, logo, color scheme, font, or any other visual representation of a parameter associated with the automatic social loan(s) 162, such as, for example, the payee of the user 106 associated with the automatic social loan(s) 162, the social lender 108, a provider of electronic rewards, a financial institution, etc. The graphic is configured to be displayed on a graphical user interface provided by a computing system. In some embodiments, the graphic is assigned to a social networking account (e.g., profile) of the account holder. The graphic may be displayed alongside a social networking profile of the user 106 and/or of the social lender 108 as part of a graphical user interface associated with the social network 110.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A computer-implemented method comprising:
generating, by a pattern mining circuit of a provider computing system, a prediction of a likelihood that a future payment transaction for a funds account associated with a user of the provider computing system will occur that causes a predicted shortfall amount in the funds account associated with the user
determining, without receiving a request from the user for funds, a pre-authorization of the user from a particular social lender for a loan at least in the amount of the predicted shortfall amount;
initiating, by one or more processors of the provider computing system, a funds transfer from a social lender account associated with the particular social lender to the funds account to cover the shortfall amount, the funds transfer comprising a socially-funded loan; and
generating a notification and providing the notification to the user, the notification indicative of the funds transfer and terms of the socially-funded loan.

2. The method of claim 1, wherein at least one user of the provider computing system is associated with the social lender account, the at least one user being provided with a subscription notification, the subscription notification structured to allow the at least one user to opt into automatic social overdraft protection as a social lender capable of issuing the socially-funded loan.

3. The method of claim 1, wherein the at least one property of the payment transaction is a payment amount on a credit account associated with the user, the method further comprising recommending the payment amount to the user based on an evaluation of at least a total monthly funds outflow of the user against a total monthly funds inflow of the user and a goal set by the user.

4. The method of claim 1, further comprising matching, by the one or more processors of the provider computing system, a cost-effective social loan issued by one of a plurality of social lenders to the user to cover the shortfall;
wherein the cost-effective social loan comprises a minimized loan cost.

5. The method of claim 4, wherein the minimized loan cost is determined, by the one or more processors of the provider computing system, based on a social lending relationship between the user and a social lender from the plurality of social lenders.

6. The method of claim 5, wherein the social lending relationship comprises a historical record comprising a prior loan between the user and the social lender, and wherein the one or more processors of the provider computing system is structured to compute an interest rate for the cost-effective social loan based on an assessment of the social lending relationship.

7. The method of claim 5, wherein the social lending relationship comprises an indicator denoting a degree of familiarity between the user and the social lender, and wherein the one or more processors of the provider computing system is structured to select the social lender based on an assessment of the degree of familiarity.

8. The method of claim 1, wherein the funds account is interest-bearing, and wherein the at least one property of the payment transaction is a calendar date selected from a range of acceptable calendar dates, the method further comprising determining, by the one or more processors of the provider computing system, the range of acceptable calendar dates such that an average daily balance of the funds account is maximized to increase an amount of interest earned.

9. The method of claim 1, wherein the automatic socially-funded loan is a first automatic socially-funded loan structured to cover the shortfall in part, and wherein the social lender account is a first social lender account;
the method further comprising initiating, by the one or more processors of the provider computing system, a funds transfer from a second social lender account, the funds transfer comprising a second automatic socially-funded loan to the funds account to cover the shortfall amount in part.

10. The method of claim 1, further comprising:
predicting an average monthly funds inflow of the funds account and a series of pre-defined time periods, each of the series of pre-defined time periods associated with a predicted recurring shortfall; and
initiating, for each of the series of pre-defined time periods, a series of recurring automatic socially-funded loans.

11. The method of claim 10, wherein each of the series of recurring automatic socially-funded loans is associated with a social lender determined at the time each of the series of recurring automatic socially-funded loans is initiated such that each current match of the user with the social lender minimizes a loan cost for the user.

12. The method of claim 1, further comprising:
calculating a risk score of the user;
comparing the risk score of the user to a risk tolerance threshold of a social lender associated with the social lender account; and
calculating an amount of the socially-funded loan, wherein the amount of the socially-funded loan corresponds to a partial shortfall amount reflective of the risk tolerance threshold of the social lender.

13. The method of claim 1, wherein the social lender is selected from a list of members of an electronic social network associated with the user based on a threshold loan amount determined by the social lender.

14. The method of claim 13, further comprising setting the pre-determined interest rate based at least on an evaluation of a social network relationship between the user and the social lender.

15. The method of claim 13, further comprising setting the pre-determined interest rate based at least on a lending activity history between the user and the social lender.

16. The method of claim 1, wherein the user is a first user and the funds account is a first funds account, and wherein generating the prediction comprises:
generating a first data set comprising payment transaction information associated with the first funds account associated with the first user of the provider computing system;
generating a second data set comprising payment transaction information associated with a second account associated with a second user of the provider computing system;
integrating the first data set and the second data set to generate a transaction pattern repository; and
evaluating each of the first data set and the second data set against at least one attribute to predict the future payment transaction for the first funds account of the user.

17. The method of claim 16, wherein the social lender account is the second funds account.

18. The method of claim 16, further comprising excluding, from the first data set, a predicted future payment transaction determined to be a payment on a previously taken socially-funded loan.

19. A computing system comprising:
a network interface; and
one or more processors embodying a pattern mining circuit configured to:
generate a prediction of a likelihood that a future payment transaction for a funds account associated with a user of a provider computing system will occur that causes a predicted shortfall amount in the funds account associated with the user;
determine, without receiving a request from the user for funds, a pre-authorization of the user from a particular social lender for a loan at least in the amount of the predicted shortfall amount;
initiate, through the network interface, a funds transfer from a social lender account to the funds account associated with the particular social lender to cover the shortfall amount, the funds transfer comprising a socially-funded loan; and
generate a notification and provide, through the network interface, the notification to the user, the notification indicative of the funds transfer and terms of the socially-funded loan.

20. The computing system of claim 19, wherein the one or more processors is further configured to match a cost-effective social loan issued by one of a plurality of social lenders to the user to cover the shortfall; and
wherein the cost-effective social loan comprises a minimized loan cost.

21. The computing system of claim 20, wherein the one or more processors is further configured to determine the minimized loan cost based on a social lending relationship between the user and a social lender from the plurality of social lenders.

22. The computing system of claim 19, wherein the automatic socially-funded loan is a first automatic socially-funded loan structured to cover the shortfall in part;
wherein the social lender account is a first social lender account; and
wherein the one or more processors is further configured to initiate, through the network interface, a funds transfer from a second social lender account, the funds transfer comprising a second automatic socially-funded loan to the funds account to cover the shortfall amount in part.

23. The computing system of claim 19, wherein the one or more processors is further configured to:
predict an average monthly funds inflow of the funds account and a series of pre-defined time periods, each of the series of pre-defined time periods associated with a predicted recurring shortfall; and
initiate, for each of the series of pre-defined time periods, a series of recurring automatic socially-funded loans.

24. The computing system of claim 19, wherein the user is a first user and the funds account is a first funds account, and wherein the one or more processors is further configured to:
generate a first data set comprising payment transaction information associated with the first funds account associated with the first user of the provider computing system;
generate a second data set comprising payment transaction information associated with a second account associated with a second user of the provider computing system;
integrate the first data set and the second data set to generate the transaction pattern repository; and
evaluate each of the first data set and the second data set against at least one attribute to predict the future payment transaction for the first funds account of the user.

25. A non-transitory computer-readable media having computer-executable instructions embodied therein that, when executed by one or more processors of a provider computing system, cause the one or more processors to perform operations, the operations comprising:
generating, by a pattern mining circuit of a provider computing system, a prediction of a likelihood that a future payment transaction for a funds account associated with a user of the provider computing system will occur that causes a predicted shortfall amount in the funds account associated with the user
determining, without receiving a request from the user for funds, a pre-authorization of the user from a particular social lender for a loan at least in the amount of the predicted shortfall amount;
initiating, by one or more processors of the provider computing system, a funds transfer from a social lender account associated with the particular social lender to the funds account to cover the shortfall amount, the funds transfer comprising a socially-funded loan; and
generating a notification and providing the notification to the user, the notification indicative of the funds transfer and terms of the socially-funded loan.

26. The non-transitory computer-readable media of claim 25, the operations further comprising matching a cost-effective social loan issued by one of a plurality of social lenders to the user to cover the shortfall;
wherein the cost-effective social loan comprises a minimized loan cost.

27. The non-transitory computer-readable media of claim 26, wherein the minimized loan cost is determined based on a social lending relationship between the user and a social lender from the plurality of social lenders.

28. The non-transitory computer-readable media of claim 25, wherein the automatic socially-funded loan is a first automatic socially-funded loan structured to cover the shortfall in part, and wherein the social lender account is a first social lender account;
the operations further comprising initiating a funds transfer from a second social lender account, the funds transfer comprising a second automatic socially-funded loan to the funds account to cover the shortfall amount in part.

29. The non-transitory computer-readable media of claim 25, the operations further comprising:
predicting an average monthly funds inflow of the funds account and a series of pre-defined time periods, each of the series of pre-defined time periods associated with a predicted recurring shortfall; and
initiating, for each of the series of pre-defined time periods, a series of recurring automatic socially-funded loans.

30. The non-transitory computer-readable media of claim 25, wherein the user is a first user and the funds account is a first funds account, and wherein generating the prediction comprises:
generating a first data set comprising payment transaction information associated with the first funds account associated with the first user of the provider computing system;
generating a second data set comprising payment transaction information associated with a second account associated with a second user of the provider computing system;
integrating the first data set and the second data set to generate the transaction pattern repository; and
evaluating each of the first data set and the second data set against at least one attribute to predict the future payment transaction for the first funds account of the user.

31. The method of claim 1, wherein the terms are automatically calculated.

32. The method of claim 1, further comprising:
generating a transaction pattern repository, the transaction pattern repository comprising at least one attribute descriptive of a property of a payment transaction;
determining that a subset of payment transaction information of the funds account matches against the at least one attribute;
determining a future time period when the future payment transaction is likely to occur and an anticipated balance of the funds account for the future time period; and
determining the shortfall amount based on evaluating the future payment transaction for the funds account against the anticipated balance of the funds account.

33. The method of claim 1, wherein the at least one attribute comprises a first social networking alias of the user.
